(19) United States
(12) Patent Application Publication
(10) Pub. No.: US 2026/0008951 A1
(43) Pub. Date: Jan. 8, 2026

(54) HYDROGEN SULFIDE SCAVENGING COMPOSITIONS

(71) Applicant: Swellfix UK Limited, Westhill, Aberdeenshire (GB)

(72) Inventors: Li JIANG, Katy, TX (US); Suzanne STEWART, Cypress, TX (US); Jonathan ABBOTT, Aberdeen (GB)

(73) Assignee: Swellfix UK Limited, Westhill, Aberdeenshire (GB)

(21) Appl. No.: 18/992,828

(22) PCT Filed: Jul. 12, 2023
(86) PCT No.: PCT/GB2023/051822

§ 371 Date: Jan. 9, 2025

(30) Foreign Application Priority Data
Jul. 12, 2022 (GB) 2210250.3

(51) Int. Cl. C09K 8/54; C09K 8/60; E21B 41/02

(52) U.S. Cl. CPC C09K 8/54; C09K 8/604; E21B 41/02; C09K 2208/08; C09K 2208/20

(57) ABSTRACT

A composition capable of scavenging or reducing sulfur-containing compounds in a fluid comprises a hydrogen sulfide scavenger; and a dispersant, wherein the dispersant comprises or consists of microfibrillated cellulose (MFC).

### FIELD OF THE INVENTION

The present invention relates to compositions and methods for treating a wellbore, subterranean formation or reservoir. In particular, but not exclusively, the invention relates to compositions and methods for scavenging or reducing sulfur-containing compounds, e.g. hydrogen sulfide, in a treatment fluid.

### BACKGROUND

Hydrocarbon fluids such as oil and natural gas are produced from a subterranean geologic formation, commonly referred to as a reservoir, by drilling a well that penetrates the hydrocarbon-bearing formation. Once a wellbore is drilled, various components forming part of a well completion assembly may be installed in order to control and enhance production of the various fluids of interest from the reservoir.

When drilling or completing wells in subterranean formations, various fluids may be injected into the well for a variety of objectives. Such fluids will be herein referred to as “treatment fluids.” Common uses for treatment fluids include: lubrication and cooling of drill bit, cutting surfaces while drilling generally or drilling-in (i.e., drilling in a targeted petroleum bearing formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, in placing a packer fluid, abandoning the well or preparing the well for abandonment, and otherwise treating the well, formation or reservoir.

In drilling some subterranean formations, and particularly those bearing oil or gas, accumulation of sulfur-containing species is frequently encountered. Typical sulfur-containing species include hydrogen sulfide, and organo-thiols as part of the produced fluid in either gas, condensate or dissolved (in oil and/or water) form. Circulation of the drilling fluid brings the hydrogen sulfide gas to the surface. The presence of hydrogen sulfide gas in the drilling fluid is problematic, as it can corrode metal such as steel in the drilling apparatus and may be liberated into the atmosphere as toxic sulfide gas at the well surface. Further, oil from the drilling fluid (as well as any oil from the formation) maybe become associated with or absorbed onto the surfaces of the cuttings that are removed from the formation being drilled. The cuttings may then be an environmentally hazardous material, making disposal a problem.

Generally, to protect the health of those handling various treatment fluids and those at the surface of the well, conditions should be maintained to ensure that the concentration of hydrogen sulfide gas above the fluid headspace, emitted due to the partial pressure of the gas, is less than about 15 ppm. The partial pressure of hydrogen sulfide at ambient temperature is a function of the concentration of sulfide ions in the aqueous fluid and of the pH of the aqueous fluid, and also depends on the nature of the fluid. To ensure that the limit of 15 ppm is not exceeded even for the maximum sulfide concentration that may be encountered in a subterranean formation, the pH of the drilling fluid is typically maintained at a minimum of about 11.5. Also, to prevent the soluble sulfide concentration in the fluid from becoming excessive, action is routinely taken to remove sulfide from the fluid.

Dissolved gases may cause many problems in the oil field. Gases and other fluids present in subterranean formations, collectively called reservoir fluids, are prone to enter a wellbore drilled through the formation. In many cases, dense drilling fluids, completion brines, fracturing fluids, and so forth are provided to maintain a countering pressure that restrains the reservoir fluids from entering the wellbore. However, there are many instances where the counter pressure is too low to restrain the reservoir fluids. This may be due to, for example, a mis-calculation of the fluid density needed to maintain a hydrostatic overbalance or a transient lowering of pressure due to movement of the drill string in the hole. Gasses may also enter the wellbore through molecular diffusion if there is insufficient flux of fluid from the wellbore to keep it swept away. Finally, reservoir fluids escape from the fragments of the formation that are being drilled up. The reservoir fluid that enters the well is then free to mix with the supplied well fluid and rise to the surface.

The hazards of un-restrained expansions of reservoir fluids in the wellbore are well known. A primary hazard is an avalanche effect of gas evolution and expansion, wherein gas bubbles rise in a liquid stream, expanding as they rise. As the bubbles expand, they expel denser fluid from the bore, and further reduce the hydrostatic pressure of the wellbore fluid. Such a progression may eventually lead to a “blow out”, whereby so much restraining pressure has been lost that the high pressure reservoir can flow uncontrollably into the wellbore.

Less dramatic, but equally important, are chemical effects that formation fluids may have upon the treatment fluids, the structure of the well, and the associated personnel. These effects and risks may include, for example: methane gas liberated at the surface may ignite; carbon dioxide may become carbonic acid, a highly corrosive compound, when exposed to water; carbon dioxide gas ay act as an asphyxiant; hydrogen sulfide can corrode ferrous metals, particularly in contact with water, and is significantly more damaging than carbon dioxide because it can induce hydrogen embrittlement, where embrittled tubulars may separate or break well under design stresses with catastrophic consequences; hydrogen sulfide gas is also toxic, with levels of 800 to 1000 ppm causing immediate death to healthy individuals. Removing dissolved and entrained gases is thus vital to many aspects of successful drilling and exploitation.

Treatment fluids from wells are typically sent offsite for treatment and processing to remove hazardous materials from the treatment fluid. For example, gases, such as hydrogen sulfide, solids, for example amounts of earth formation, cuttings, debris, etc., and other fluids, for example oil, may be removed from the process fluid during such processing of the treatment fluid so that the treatment fluids offsite is inevitably cumbersome and costly due to the potential risks involved, including health risks for personnel handling the transport of the treatment fluids and environmental risks of leakage or spillage of the treatment fluid during transportation.

Accordingly, there exists a need for a system and method for treating a treatment fluid, including facilitating the reduction of entrained and dissolved gases in particular hydrogen sulfide in the treatment fluid.

Common strategies aimed at dealing with entrained and dissolved gases of acidic nature, i.e. carbon dioxide and hydrogen sulfide, include making the treatment fluid extremely alkaline, e.g. pH of about 11.5, so as to transform such gases into water-soluble ionic species. Such an approach may cause, however, undesirable effects including divalent metal carbonate and sulfide solids generation in fluid bulk and scale hazard to metal tubulars, valves and pumps.

The use of hydrogen sulfide scavengers is well known. Common hydrogen sulfide scavengers include an oxidant, such as an inorganic peroxide (e.g., sodium peroxide, or chlorine dioxide), or sodium bromated, sodium nitrite or an aldehyde having from 1-10 carbons atoms such as, for example, formaldehyde, glutaraldehyde or (meth) acrolein. Additional examples of hydrogen sulfide scavenger compounds includes amines such as, for example, monoethanolamine (MEA), diethanoloamine (DEA), diisopropylamine, diglycolamine (DGA), N-methyldiethanolamine (MDEA), triazine and derivatives (e.g. 2,4,6-triamino-1,3,5-triazine, Melamine). Due to a lack of thermal stability and proper delivery methods, these materials are limited only for wellsite treatment of hydrogen sulfide at temperatures below 140° F.

A common type of water-soluble H₂S scavenger are triazine-based compounds and derivatives.

Triazine-based H₂S scavengers undergo a basic reaction with H₂S as outlined below in Scheme 1.

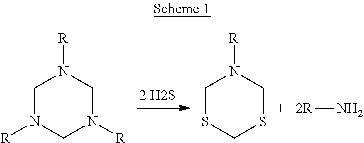

Scheme 1 shows the reaction pathway of an exemplary H₂S scavenging triazine compound, leading to a water insoluble by-product: dithiazine. It is essentially a sequential nucleophilic substitution reaction where two nitrogen atoms on the 6-member triazine ring are replaced by sulfur atoms, with subsequent release of ethanolamine.

However, the spontaneous polymerization of dithiazine into polysulfide species leads to tractable scale deposit that is the cause of severe fouling and corrosion to the equipment, hence prevents the reaction system from proceeding towards its full completion.

Thus, an intrinsic drawback of the triazine-based approach lies in the generation of a water insoluble by-product dithiazine that leads to significant precipitation out of the scavenger medium, which in turn causes premature termination of the reaction mechanism.

Common triazine compounds used in H₂S scavenging applications are shown in Table 1.

TABLE 1

| ID | Compound Name | Structure |
|---|---|---|
| 1 | Hexahydro-1,3,5-tris(hydroxy- ethyl)-s-triazine (CAS# 4719-04-4) | 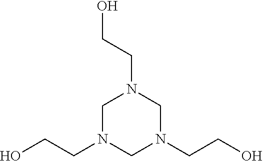 [SMILES: OCCN1CN(CCO)CN(CCO)C1] |
| 2 | 1,3,5-Trimethyl-1,3,5-triazinane (CAS# 108-74-7) | 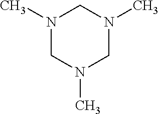 |
| 3 | 1,3-diisocyanaomethylbenzene (CAS# 26471-62-5) | 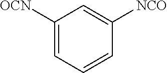 |
| 4 | 1,3,5-Triazine-1,3,5-trimethanol (CAS# 79876-19-0) | 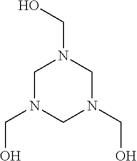 [SMILES: OCN1CN(CO)CN(CO)C1] |
| 5 | 1,3,5-triacryloylaminohexahydro- s-triazine (CAS# 959-52-4) | 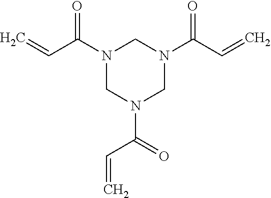 [SMILES: C=CC(=O)N1CN(C(=O)C=C)CN(C(=O)C=C)C1] |
| 6 | 1,3,5-Tris(2-hydroxyethyl)-13,5- triazine-2,4,6-trione (CAS# 839-90-7) | 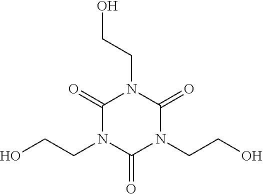 [SMILES: O=c1n(CCO)c(=O)n(CCO)c(=O)n1CCO] |
| 7 | 1,3,5-Triazine-1-carboxylic acid, tetrahydro-3,5-bis(1-oxo-2-propen- 1-yl) (CAS# 53462-02-5) | 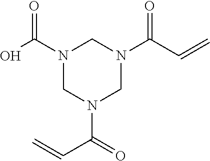 [SMILES: C=CC(=O)N1CN(C(=O)O)CN(C(=O)C=C)C1] |
| 8 | 1,3,5-Tris[(dimethylamino)ethyl] hexahydrotriazine (CAS# 30564-49-9) | 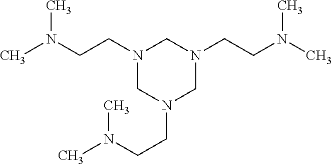 |
| 9 | 1,3,5-Tri(m-trifluoromethylphen- yl)hexahydrotriazine (CAS#38335-59-0) | 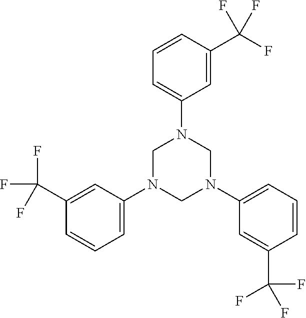 [SMILES: FC(F)(F)c1cccc(N2CN(c3cccc(C(F)(F)F)c3)CN(c3cccc(C(F)(F)F)c3)C2)c1] |
| 10 | 1,3,5-Tris[2-(diethylamino)ethyl] hexahydro-s-triazine (CAS# 61776-59-8) | 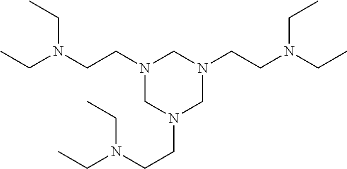 [SMILES: CCN(CC)CCN1CN(CCN(CC)CC)CN(CCN(CC)CC)C1] |
| 11 | Benzamine, 4,4′,4″-(1,3,5-tri)- tri[N,N-diphenyl-(9Cl)] (CAS#216058-18-3) | 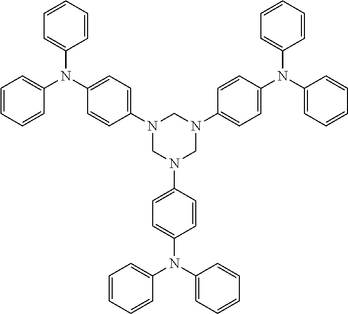 [SMILES: c1ccc(N(c2ccccc2)c2ccc(N3CN(c4ccc(N(c5ccccc5)c5ccccc5)cc4)CN(c4ccc(N(c5ccccc5)c5ccccc5)cc4)C3)cc2)cc1] |
| 12 | Hexahydro-1,3,5-tris(2-methoxy- phenyl)-1,3,5-triazine (CAS#85680-36-0) | 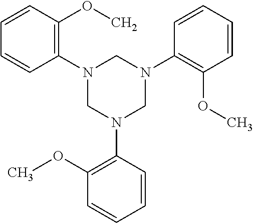 [SMILES: COc1ccccc1N1CN(c2ccccc2OC)CN(c2ccccc2OC)C1] |
| 13 | 1,3,5-Tris(2,3-dibromopropyl)- 2,4,6-trioxohexahydro-s-triazine (CAS# 52434-90-9) | 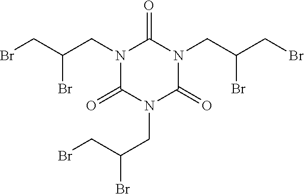 [SMILES: O=c1n(CC(Br)CBr)c(=O)n(CC(Br)CBr)c(=O)n1CC(Br)CBr] |
| 14 | 2,4,6-Trihydroxy-1,3,5-triazine (CAS# 108-80-5) | 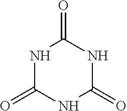 |

Triazines made from monoethanolamine (MEA) or methylamine (MA) are the most common commercially available scavengers. MEA-based triazines (1) react more efficiently in the liquid phase than other chemistries and are particularly useful if the immediate reduction of H₂S is critical; as is the case when ships or barges are loaded with H₂S-laden product and the safety of the crew is at risk. Other water-soluble H₂S scavengers include polymeric, nitrogen-based products, as well as aldehyde-based, non-nitrogen chemistries. These scavengers are typically less likely to cause any fouling and corrosion problems in crude oil distillation units and refinery process equipment.

Triazines and glyoxal are among the most common H₂S scavengers in oil and gas industries predominately in the form of bubbling towers at wellsite or refinery facilities. However, utilizing these scavengers hardly reach their theoretical limit of scavenging capacity. On the other hand triazines and glyoxal scavengers provide moderate reaction rates when used in shallow downhole injection applications. They also mentioned that neither triazines nor glyoxal are suitable H₂S scavengers for downhole injection applications, because of the low thermal stability and, in the case of triazine, the intrinsically high tendency of precipitation. In addition, it has been demonstrated that alkylamines can be formed during the hydrolysis of triazine. Formation of alkylamines causes a sudden jump in pH of the drilling fluid, which can be the cause for a number of issues in downstream processes such as production, refining operations, etc. due to carbonate scale deposition.

Examples of techniques used for hydrogen sulfide scavenging disclosed in the prior art (all of which are incorporated herein by reference) include:
Using copper based organic & inorganic compound for H₂S scavenging from asphalt, as disclosed for example in U.S. Pat. No. 10,557,036;
Using oxygen to oxidize H₂S contained in waste stream, as disclosed in U.S. Pat. No. 10,730,770 (Archer);
Using amine and formaldehyde-based H₂S scavenger, as disclosed in U.S. Pat. Nos. 6,024,866 and 7,438,877;
Using metal borate complex as H₂S scavenger, as disclosed in U.S. Pat. Nos. 8,034,231, 8,523,994, 9,068,128, and 9,334,488;
Using glyoxal and aldehyde based H₂S scavenger, as disclosed in U.S. Pat. Nos. 9,260,669, 9,278,307, 9,394,396, 9,463,989;
Using transition metal carboxylate complex based H₂S scavenger, as disclosed in U.S. Pat. No. 9,480,946;
Using transition metal salt-based H₂S scavenger, as disclosed in U.S. Pat. No. 9,587,181;
Using water-insoluble absorbent based H₂S scavenger, as disclosed in U.S. Pat. Nos. 9,656,237 and 10,434,467;
Using enzymatic H₂S scavenger, as disclosed in U.S. Pat. No. 10,465,105;
Using metal complex dispersed in organic solvent as H₂S scavenger, as disclosed in U.S. Pat. No. 10,557,036;
Using metal formaldehyde sulfoxylates as H₂S scavenger, as disclosed in U.S. Pat. No. 10,940,107;
Using triazine-based H₂S scavenger, as disclosed in U.S. Pat. No. 8,734,637;
Using triazine compounds as H₂S scavenger, as disclosed in U.S. Pat. Nos. 5,247,003, 5,405,591, 7,115,215, 10,913,029;
Using a aminopropyltriethoxysilane (APS), hydroxy-carbonated apatite (HAP), or epoxy compound coated on a cellulosic material to produce nanostructured adsorbents for the removal of H₂S (Hokkanen et al, “Adsorption of hydrogen sulfide from aqueous solutions using modified nano/micro fibrillated cellulose”; Environmental Technology; 2014.

It is an object of the invention to address and/or mitigate one or more problems associated with the prior art.

It is an object of the invention to provide an improved composition and/or method for treating a wellbore, subterranean formation or reservoir.

It is an object of the invention to provide a composition capable of scavenging or reducing dissolved gases, e.g. sulfur-containing compounds such as hydrogen sulfide, in a treatment fluid treating a wellbore, subterranean formation or reservoir.

It is an object of the invention to improve the performance of triazine-based H₂S scavenging techniques.

### SUMMARY

According to a first aspect there is provided a composition capable of scavenging or reducing sulfur-containing compounds in a fluid, the composition comprising:
a hydrogen sulfide scavenger; and
a dispersant, wherein the dispersant comprises or consists of microfibrillated cellulose (MFC).

The composition may be capable of scavenging or reducing dissolved gases in a treatment fluid. The composition may be capable of scavenging or reducing hydrogen sulfide in a treatment fluid. The composition may be hydrogen sulfide-scavenging composition.

The dispersant comprises or consists of microfibrillated cellulose (MFC).

Microfibrillated cellulose (MFC) will be herein understood as referring to cellulose fibers that have been subjected to a fibrillation process. Typically, MFC is obtained via a mechanical treatment resulting in an increase of the specific surface and a reduction of the size of cellulose fibers, in terms of cross-section (diameter) and/or length. Typically, the resulting fibrils of MFC may have a diameter in the nanometer range and a length in the micrometer range. The fibrillation process used to make MFC separates the cellulose fibers into a three dimensional network of microfibrils with a large surface area. The obtained fibrils are typically much smaller in diameter compared to the original fibers, and typically form a three-dimensional network or web-like structure.

The dispersant, e.g. microfibrillated cellulose, may be present at a concentration of about 0.01-2 wt %, e.g. about 0.05-1.5 wt %, typically about 0.1-1 wt %, based on the total weight of the composition. It will be understood that the concentration of the dispersant in the composition may be selected based on the particular use and conditions, for example based on rock type or lithology, or formation temperature.

Advantageously, the use of microfibrillated cellulose may allow the use of an environmentally-friendly material which is sustainable and biodegradable. In addition, the use of microfibrillated cellulose may help maintain a single phase formulation of both the composition, e.g. treatment fluid, and the post-treatment mixture. Advantageously, microfibrillated cellulose may confer to the composition shear thinning properties (thus allowing the composition to be pumped through the wellbore with little or negligible friction resistance, preventing or minimizing the risk of phase separation and/or of loss of undesirable residues in the formation), and/or may confer fluid loss control functionality.

The hydrogen sulfide scavenger may comprise or may consist of a lignosulfonate or derivative thereof, e.g. a lignosulfonate metal salt, as a chelating or complexing ligand.

The hydrogen sulfide scavenger may comprise or may consist of an alkylated lignosulfonate.

The hydrogen sulfide scavenger may comprise or may consist of a metal lignosulfonate. Preferably, the metal may be a metal cation such as a polyvalent or monovalent metal cation. The metal lignosulfonate may comprise one or more cations selected from the group consisting of calcium, magnesium, zinc, iron, copper, cobalt, manganese, nickel, titanium, aluminum, or combinations thereof.

In some embodiments, the hydrogen sulfide scavenger may comprise or may consist of a transition metal lignosulfonate.

Lignosulfonates may typically be formed as by-products from the production of wood pulp using sulfite pulping. Lignosulfonates may typically be aqueous soluble anionic polymers, and may have generally a wide molecular weight distribution, typically in the range of about 500 to about 200,000 Daltons.

The lignosulfonate, e.g. metal lignosulfonate, may be present at a concentration of about 0.01-90 wt %, e.g. about 0.05-50 wt %, or about 0.1-25 wt %, typically about 1-10 wt % based on the total weight of the composition. It will be understood that the concentration of the hydrogen sulfide scavenger, e.g. lignosulfonate, in the composition may be selected based on the particular use and conditions, for example based on rock type or lithology, formation temperature, or the like.

Advantageously, the use of a lignosulfonate, e.g. metal lignosulfonate, may allow the use of an environmentally-friendly material which is sustainable and biodegradable.

Advantageously, the use of a lignosulfonate, e.g. metal lignosulfonate, may provide an effective chelating ligand to the active H₂S scavenging species, e.g. cations thereof, such that the latter species is sufficiently chelated at the atomic level, which may generate the highest possible scavenging power upon encountering the target sulfide species.

Advantageously, the use of a lignosulfonate, e.g. metal lignosulfonate, may provide dispersing functionality to help maintain the treatment ready fluid in a pumpable single phase.

The hydrogen sulfide scavenger may comprise or may consist of a metal organic framework (MOF).

Metal organic frameworks are a type of coordination polymer having extended three-dimensional framework structures formed from extended chains, sheets or networks of metal ions interconnected by ligands or linkers.

As explained above, MOFs are typically formed from metal ions interconnected by ligands or linkers. The metal in the MOF framework may be any appropriate metal that is capable of providing hydrogen sulfide scavenging functionality. The MOF, e.g. metal thereof, may further allow for the loading, e.g. reversible loading, of a target chemical entity, such as, for example, a crosslinker, a breaker, or an acidizing agent, which may be advantageous in a treatment fluid.

The MOF may comprise one or more metals selected from one of the known metal-containing groups of the periodic table, such as groups Ia, IIa, IIia, IVa to VIIa and Ib to VIb of the periodic table, including metals such as, for example, Mg, Ca, Sr, Ba, Sc, Y, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, Hg, Al, Ga, In, Ti, Si, Ge, Sn, Pb, As, Sb and Bi. Ionic states of the above metals may include, for example, Mg²⁺, Ca²⁺, Sr²⁺, Ba²⁺, Sc³⁺, Y³⁺, Ti⁴⁺, Zr⁴⁺, HF⁴⁺, V⁴⁺, V³⁺, V²⁺, Nb³⁺, Ta³⁺, Cr³⁺, Mo³⁺, W³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Ti³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺and Bi⁺.

The MOF may be present at a concentration of about 0.01-90 wt %, e.g. about 0.05-50 wt %, typically about 0.1-25 wt %, based on the total weight of the composition. It will be understood that the concentration of the hydrogen sulfide scavenger, e.g. MOF, in the composition may be selected based on the particular use and conditions, for example based on rock type or lithology, formation temperature, or the like.

The hydrogen sulfide scavenger may comprise or may consist of a metal lignosulfonate encapsulated in a metal organic framework.

The metal lignosulfonate may contain one or more metal cations such as polyvalent or monovalent metal cations, e.g. one or more cations selected from the group consisting of calcium, magnesium, zinc, iron, copper, cobalt, manganese, nickel, titanium, aluminum, or combinations thereof.

The metal lignosulfonate encapsulated in a metal organic framework, may be present at a concentration of about 0.01-90 wt %, e.g. about 0.05-50 wt %, typically about 0.1-25 wt %, based on the total weight of the composition. It will be understood that the concentration of the hydrogen sulfide scavenger, e.g. metal lignosulfonate encapsulated in a metal organic framework, in the composition may be selected based on the particular use and conditions, for example based on rock type or lithology, formation temperature, or the like.

The features described above in relation to the lignosulfonate and/or in relation to the MOF are applicable, and are not repeated here, merely for brevity.

The hydrogen sulfide scavenger may comprise or may consist of a metal salt encapsulated in a metal organic framework.

The metal salt may contain one or more metal cations such as polyvalent or monovalent metal cations, e.g. one or more cations selected from the group consisting of calcium, magnesium, zinc, iron, copper, cobalt, manganese, nickel, titanium, aluminum, or combinations thereof.

The metal salt may contain one or more transition metal salts.

The metal salt encapsulated in a metal organic framework, may be present at a concentration of about 0.01-90 wt %, e.g. about 0.05-50 wt %, typically about 0.1-25 wt %, based on the total weight of the composition. It will be understood that the concentration of the hydrogen sulfide scavenger, e.g. metal salt encapsulated in a metal organic framework, in the composition may be selected based on the particular use and conditions, for example based on rock type or lithology, formation temperature, or the like.

The features described above in relation to the MOF are applicable, and are not repeated here, merely for brevity.

The hydrogen sulfide scavenger may comprise or may consist of a metal salt.

The metal salt may contain one or more metal cations such as polyvalent or monovalent metal cations, e.g. one or more cations selected from the group consisting of calcium, magnesium, zinc, iron, copper, cobalt, manganese, nickel, titanium, aluminum, or combinations thereof.

The metal salt may contain one or more transition metal salts.

The metal salt may be present at a concentration of about 0.01-90 wt %, e.g. about 0.05-50 wt %, typically about 0.1-25 wt %, based on the total weight of the composition. It will be understood that the concentration of the hydrogen sulfide scavenger, e.g. metal salt, in the composition may be selected based on the particular use and conditions, for example based on rock type or lithology, formation temperature, or the like.

The hydrogen sulfide scavenger may comprise or may consist of a triazine compound.

The hydrogen sulfide scavenger may comprise or may consist of a triazine compound made from or derived from monoethanolamine (MEA) or methylamine (MA).

The hydrogen sulfide scavenger may comprise one or more triazine compounds selected from the list consisting of hexahydro-1,3,5-tris (hydroxyethyl)-s-triazine, 1,3,5-Trimethyl-1,3,5-triazinane, 1,3-diisocyanaomethylbenzene, 1,3,5-Triazine-1,3,5-trimethanol, 1,3,5-triacryloylaminohexahydro-s-triazine, 1,3,5-Tris (2-hydroxyethyl)-13,5-triazine-2,4,6-trione, 1,3,5-Triazine-1-carboxylic acid, tetrahydro-3,5-bis(1-oxo-2-propen-1-yl), 1,3,5-Tris[(dimethylamino)ethyl]hexahydrotriazine, 1,3,5-Tri(m-trifluoromethylphenyl) hexahydrotriazine, Benzamine-4,4′,4″-(1,3,5-tri)tri[N,N-diphenyl-(9Cl)], hexahydro-1,3,5-tris(2-methoxyphenyl)-1,3,5-triazine, 1,3,5-Tris(2,3-dibromopropyl)-2,4,6-trioxohexahydro-s-triazine, and 2,4,6-Trihydroxy-1,3,5-triazine.

The triazine compound may be present at a concentration of about 0.01-90 wt %, e.g. about 0.05-75 wt %, typically about 0.1-50 wt %, based on the total weight of the composition. It will be understood that the concentration of the hydrogen sulfide scavenger, e.g. triazine compound, in the composition may be selected based on the particular use and conditions, for example based on rock type or lithology, formation temperature, or the like.

The composition may be a composition capable of treating a wellbore, subterranean formation or reservoir.

The composition may further comprise a treatment fluid.

Thus, in an embodiment, the composition may comprise:
a treatment fluid;
a hydrogen sulfide scavenger; and
a dispersant, wherein the dispersant comprises or may consist of microfibrillated cellulose (MFC).

The treatment fluid may comprise or may be a stimulating fluid. The stimulating fluid may comprise or may be an acid. In such instance, the composition may be an acid treatment composition. The composition may be suitable for use in acid treatment, e.g. acid stimulation, of a wellbore, subterranean formation or reservoir.

The treatment fluid may comprise or may be a lubrication fluid and/or a drilling fluid.

The treatment fluid may comprise or may be a pressure-control fluid.

The treatment fluid may comprise or may be a fracturing fluid.

The treatment fluid may comprise or may be a displacement fluid, e.g. to displace a fluid within the well, formation or reservoir with the displacement fluid.

The composition may be a composition capable of treating a fluid retrieved from a wellbore, subterranean formation or reservoir. The composition may be suitable for treating the fluid in a treatment system, e.g. at surface.

This may be particularly suitable when the hydrogen sulfide scavenger comprises or consists of a triazine compound.

Advantageously, the present composition may help prevent the by-product of the triazine-H₂S reaction from being aggregated and polymerized into corrosive species which are harmful to conventional industrial reaction vessels.

Advantageously, the combination of ingredients of the present invention provides a treatment composition suitable for treating a wellbore, subterranean formation or reservoir, which composition may be environmentally-friendly, may exhibit shear thinning properties (thus allowing the composition to be pumped through the wellbore with little or negligible friction resistance, preventing or minimizing the risk of phase separation and/or of loss of undesirable residues in the formation), and/or may exhibit fluid loss control functionality. Other potential advantages of the present composition include improved mixing properties with commonly used gelling agents, potential capability of dispersing in any brine over a wider range of pH levels, potential relative ease of additive hydration in the presence of certain common contaminants, potential capability of compatibility with formation brine (potentially saving time and cost), and potential ability to be directly blended into a mineral acid.

The composition may comprise or may further comprise a base fluid.

The base fluid may be an aqueous base fluid. The base fluid may comprise fresh water, salt water, seawater, a brine (e.g., a saturated salt-water brine or a formation brine), or a combination thereof.

The base fluid may be an organic base fluid, e.g. a solvent. Organic solvents may include any organic solvent that is able to dissolve or suspend one or more components of the composition, such as reactants for forming the MOF and/or components of the treatment fluid. Suitable organic solvents may include, for example, alcohols, glycols, esters, ketones, nitrites, amides, amines, cyclic ethers, glycol ethers, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diethylene glycol dimethyl ether, 1,2-dimethoxy-ethane (DME), dimethylether, dibutylether, dimethyl-formamide (DMF), dimethyl sulfoxide (DMSO), dioxane, ethanol, ethyl acetate, ethylene glycol, glycerin, heptanes, hexamethylphosphoramide (HMPA), hexamethylphosphorous triamide (HMPT), hexane, methanol, methyl t-butyl ether (MTBE), methylene chloride, N-methyl-2-pyrrolidinone (NMP), nitromethane, pentane, petroleum ether (ligroine), 1-propanol, 2-propanol, pyridine, tetrahydrofuran (THF), toluene, triethyl amine, o-xylene, m-xylene, p-xylene, ethylene glycol monobutyl ether, polyglycol ethers, pyrrolidones, N-(alkyl or cycloalkyl)-2-pyrrolidones, N-alkyl piperidones, N, N-dialkyl alkanolamides, N,N,N′, N′-tetra alkyl ureas, dialkylsulfoxides, pyridines, hexaalkylphosphoric triamides, 1,3-dimethyl-2-imidazolidinone, nitroalkanes, nitrocompounds of aromatic hydrocarbons, sulfolanes, butyrolactones, alkylene carbonates, alkyl carbonates, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, dibutyl carbonate, lactones, nitromethane, nitrobenzene sulfones, tetrahydrofuran, dioxane, dioxolane, methyltetrahydrofuran, dimethylsulfone, tetramethylene sulfone, diesel oil, kerosene, paraffmic oil, crude oil, liquefied petroleum gas (LPG), mineral oil, biodiesel, vegetable oil, animal oil, aromatic petroleum cuts, terpenes, perchloroethylene, methylene chloride, or mixtures thereof.

Typically, in the composition, the hydrogen sulfide scavenger and the dispersant may form different phases, e.g. may form a heterogeneous composition. For example, the dispersant, e.g. MFC, may be dispersed in the base fluid. The hydrogen sulfide scavenger may be dissolved or dispersed in the based fluid. The hydrogen sulfide scavenger and the dispersant may be present as distinct components in the composition.

The hydrogen sulfide scavenger may not be encapsulated or may not form a coating on the dispersant. By such provision, the dispersant is capable of providing the advantageous effects described herein, so as to facilitate surface interactions to promote hydrogen sulfide scavenging functionality.

The composition may comprise one or more additives.

The composition may comprise a fluid loss additive. Whilst the inventors have discovered that the presence of microfibrillated cellulose in the composition may provide advantageous fluid loss properties to the composition, it may be desirable in some instances to include one or more fluid loss additives in order to fine-tune the properties of the composition.

Advantageously, a fluid loss additive may be selected to be compatible with the composition, e.g. treatment fluid, of the present invention.

The fluid loss additive may comprise one or more compounds selected from the list consisting of starches, silica flour, and diesel dispersed in a fluid.

The fluid loss additive may comprise a degradable material, which may include one or more compounds, e.g. polymers, selected from the list consisting of polysaccharides such as dextran or cellulose; chitins; chitosans; proteins; aliphatic polyesters; poly(lactides); poly(glycolides); poly(glycolide-co-lactides); poly(ε-caprolactones); poly(3-hydroxybutyrates); poly(3-hydroxybutyrate-co-hydroxyvalerates); poly(anhydrides); aliphatic poly(carbonates); poly(orthoesters); poly(amino acids); poly(ethylene oxides); poly(phosphazenes); derivatives thereof; or combinations thereof.

The fluid loss additive may be present in the composition at a concentration of about 5 to 100 pounds per 1000 gallons, e.g. about 10 to about 50 pounds per 1000 gallons, of the composition.

According to a second aspect there is provided a composition capable of treating a wellbore, subterranean formation or reservoir, or surface facilities, the composition comprising:
a treatment fluid;
a hydrogen sulfide scavenger; and
a dispersant, wherein the dispersant comprises or may consist of microfibrillated cellulose (MFC).

The surface facilities may include a treatment tower, a pipeline and/or a refinery vessel.

The treatment fluid may comprise or may be a stimulating fluid. The stimulating fluid may comprise or may be an acid. In such instance, the composition may be an acid treatment composition. The composition may be suitable for use in acid treatment, e.g. acid stimulation, of a wellbore, subterranean formation or reservoir.

The treatment fluid may comprise or may be a lubrication fluid and/or a drilling fluid.

The treatment fluid may comprise or may be a pressure-control fluid.

The treatment fluid may comprise or may be a fracturing fluid.

The treatment fluid may comprise or may be a displacement fluid, e.g. to displace a fluid within the well, formation or reservoir with the displacement fluid.

The features described in relation to the composition of the first aspect may equally apply to the composition of the second aspect, and, merely for brevity, are not repeated.

According to a third aspect, there is provided a method of scavenging or reducing sulfur-containing compounds in a treatment fluid, the method comprising providing in the treatment fluid a composition comprising:
a hydrogen sulfide scavenger; and
a dispersant, wherein the dispersant comprises or may consist of microfibrillated cellulose (MFC).

According to a fourth aspect, there is provided a method of treating a wellbore, subterranean formation or reservoir, or surface facilities, the method comprising injecting in the wellbore, subterranean formation or reservoir, or surface facilities a composition comprising:
a treatment fluid;
a hydrogen sulfide scavenger; and
a dispersant, wherein the dispersant comprises or may consist of microfibrillated cellulose (MFC).

The surface facilities may include a treatment tower, a pipeline and/or a refinery vessel.

The method may comprise injecting or placing a composition according to the second aspect.

According to a fifth aspect, there is provided a method of treating a fluid retrieved from a wellbore, subterranean formation or reservoir wellbore, or surface facilities, the method comprising contacting the fluid with a composition comprising:
a hydrogen sulfide scavenger; and
a dispersant, wherein the dispersant comprises or may consist of microfibrillated cellulose (MFC).

The hydrogen sulfide scavenger may comprise or may consist of a triazine compound.

The surface facilities may include a treatment tower, a pipeline and/or a refinery vessel.

The method may be carried out at surface.

The method may comprise injecting the fluid in or passing the fluid through the composition, e.g. in a treatment apparatus such as a treatment tower, a pipeline and/or a refinery vessel.

Advantageously, the present composition may help prevent the by-product of the triazine-H₂S reaction from being aggregated and polymerized into corrosive species which are harmful to conventional industrial reaction vessels.

The features described in relation to any aspect of the invention may equally apply to any other aspect and, merely for brevity, are not repeated. For example, features described in relation to compositions can apply in relation to methods, and vice versa.

### BRIEF DESCRIPTION OF DRAWINGS

The invention will be described with reference to the accompanying drawings, in which:

FIG. 1 shows the results of an amplitude sweep test for 0.5 wt % Exilva™ MFC in DI water, compared to the same amount of other cellulose or saccharide derivatives including HEC, CMC, guar gum and xanthan gum.

FIG. 2 shows the results of a shear viscosity test for the same components as those of FIG. 1, depicting viscosity against shear rate.

### DETAILED DESCRIPTION

As explained above, the present inventors have discovered improved compositions for treating a wellbore, subterranean formation or reservoir. In particular, the present inventors have discovered improved compositions for scavenging or reducing dissolved gases in a treatment fluid.

Typically, the composition capable of scavenging or reducing dissolved gases in a treatment fluid comprises:
a hydrogen sulfide scavenger; and
a dispersant, wherein the dispersant comprises or may consist of microfibrillated cellulose (MFC).

Advantageously, the use of microfibrillated cellulose may allow the use of an environmentally-friendly material which is sustainable and biodegradable. In addition, the use of microfibrillated cellulose may help maintain a single phase formulation of both the composition, e.g. treatment fluid, and the post-treatment mixture. Advantageously, microfibrillated cellulose may confer to the composition shear thinning properties (thus allowing the composition to be pumped through the wellbore with little or negligible friction resistance, preventing or minimizing the risk of phase separation and/or of loss of undesirable residues in the formation), and/or may confer fluid loss control functionality.

When the composition is for treating a wellbore, subterranean formation or reservoir, the composition comprises:
a treatment fluid;
a hydrogen sulfide scavenger; and
a dispersant, wherein the dispersant comprises or may consist of microfibrillated cellulose (MFC).

Microfibrillated cellulose (MFC) will be herein understood to refer to cellulose fibers that have been subjected to a fibrillation process. Typically, MFC is obtained via a mechanical treatment resulting in an increase of the specific surface and a reduction of the size of cellulose fibers, in terms of cross-section (diameter) and/or length. Typically, the resulting fibrils of MFC may have a diameter in the nanometer range and a length in the micrometer range. The fibrillation process used to make MFC separates the cellulose fibers into a three dimensional network of microfibrils with a large surface area. The obtained fibrils are typically much smaller in diameter compared to the original fibers, and typically form a three-dimensional network or web-like structure.

The dispersant, e.g. microfibrillated cellulose, may be present at a concentration of about 0.01-2 wt %, e.g. about 0.05-1 wt %, typically about 0.1-0.5 wt %, based on the total weight of the composition. It will be understood that the concentration of the dispersant in the composition may be selected based on the particular use and conditions, for example based on rock type or lithology, formation temperature.

Advantageously, the use of microfibrillated cellulose may allow the use of an environmentally-friendly material which is sustainable and biodegradable. In addition, the use of microfibrillated cellulose may help maintain a single phase formulation of both the composition, e.g. treatment fluid, and the post-treatment mixture. Advantageously, microfibrillated cellulose may confer to the composition shear thinning properties (thus allowing the composition to be pumped through the wellbore with little or negligible friction resistance, preventing or minimizing the risk of phase separation and/or of loss of undesirable residues in the formation), and/or may confer fluid loss control functionality.

Microfibrillated cellulose, also known as “reticulated” cellulose, “superfine” cellulose, or “cellulose nanofibrils”, among others, is a cellulose-based product whereby the cellulose fibers have been subjected to a fibrillation process. The fibrillation process typically includes a first step involving soaking and dispersing a pulp in water. Subsequently, the cellulose fibers are transformed into microfibrils using a process involving high shear forces. To create such shear forces, different methods can be used, including for example a high pressure homogenizer, grinding, cryocrushing, high intensity ultrasonication, or electrospinning.

Examples of such a fibrillation process for making MFC are described in U.S. Pat. No. 4,481,077 (Herrick), U.S. Pat. No. 4,374,702 (Turbak et al) and U.S. Pat. No. 4,341,807 (Turbak et al), which are all incorporated herein by reference. In particular, U.S. Pat. No. 4,374,702 (Turbak et al) describes a process for making MFC which involves passing a liquid suspension of cellulose through a small diameter orifice in which the suspension is subjected to a pressure drop of at least 3000 psig and a high velocity shearing action followed by a high velocity decelerating impact, and repeating the passage of said suspension through the orifice until the cellulose suspension becomes a substantially stable suspension. The process converts the cellulose pulp into microfibrillated cellulose without substantial chemical change of the cellulose starting material.

According to U.S. Pat. No. 4,374,702, microfibrillated cellulose has distinct properties vis-à-vis cellulose products not subjected to the mechanical treatment disclosed in U.S. Pat. No. 4,374,702. In particular, the microfibrillated cellulose described in these documents has reduced length scales (diameter, fiber length), improved water retention and adjustable viscoelastic properties. MFC with further improved properties and/or properties tailor-made for specific applications is known, among others, from WO 2007/091942 and WO 2015/180844.

Other types of cellulose fiber exist, for example, nanofibrillated cellulose (NFC), or microcrystalline cellulose, which are different from MFC in their dimensions, structures and/or properties.

Nanofibrillated cellulose can be defined as a material having a length dimension of 100 nm or less with very high specific area and high porosity. CNF is made of nanosized cellulose fibrils having a high aspect ratio (length to width ratio). Typical CNF fibril widths may be in the region of 5-20 nm with a wide range of lengths, typically several μm.

In microcrystalline cellulose, the amorphous, accessible regions of the cellulose are either degraded or dissolved away leaving the less accessible crystalline regions as fine crystals a few tens of microns in size. In preparing microcrystalline cellulose, it is necessary to destroy a significant part of the cellulose to produce the final product, and consequently, it is quite expensive. In addition, most of the desirable amorphous reactive part of the fiber is removed and destroyed leaving only the microcrystals which are primarily surface reactive.

For microfibrillated cellulose, optical microscopic imaging under appropriate magnification reveals the morphology at the ends of the fibrils as well as the fibril lengths and the degree of entanglements of fibrils in the MFC network structure, thus allowing for conclusions on how the morphology of the fibrils on that level determines the macrostructure of the MFC material, which in turn is responsible for the physical properties as described in the present disclosure.

Such a magnification of was chosen to have a reasonable number of fibrils in the given area of the image to be counted, at the given concentration of the MFC material. By means of optical microscopy, individual fibrils or fibril bundles or fibre fragments with cross sectional diameter larger than approximately 200 nm can be studied. Fibrils with cross-sectional diameter below this range cannot be fully resolved or seen, but will be present, coexisting with the fibrils or fibril bundles that can be resolved by optical microscopy as described herein.

The (micro)fibrils and their morphology is/are described, throughout the present disclosure, exclusively based on structures discernible at the microscopic level, i.e. as discernible by means of optical microscopy as described herein. The skilled person understands that additional structural and/or morphological information may be discernible at a higher magnification or by use of other methods, in particular by methods that have a better resolution.

In cellulose, which is the starting product for producing microfibrillated cellulose within the meaning of the present application (typically present as a “cellulose pulp”), no, or at least not a significant or not even a noticeable portion of individualized and “separated” cellulose “fibrils” can be found. The cellulose in wood fibres is an aggregation of fibrils. In cellulose (pulp), elementary fibrils are aggregated into microfibrils which are further aggregated into larger fibril bundles and finally into cellulosic fibres. The diameter of wood-based fibres is typically in the range of 10-50 μm (with the length of these fibres being even greater). When the cellulose fibres are microfibrillated, a heterogeneous mixture of “released” fibrils with cross-sectional dimensions and lengths from nm to um may result. Fibrils and bundles of fibrils may co-exist in the resulting microfibrillated cellulose.

Throughout the present disclosure, the term “fibril” is to be understood as relating to (aggregates of) cellulose molecules/fibrils with cross-sectional dimensions (diameters) from 2 nm to 1 μm, including both individual fibrils and fibril bundles. Fibril bundles or aggregates exceeding 1 μm in diameter are considered as ‘residual fibre fragments’ throughout the present disclosure.

In accordance with the present disclosure, the fibrils of the MFC preferably have a diameter in the nanometer range and a length in the um range. Preferably, the diameter of the MFC fibrils making up the MFC is in the range from 1 nm to 1000 nm, preferably, and on average, from 10 nm to 500 nm.

In accordance with the present disclosure, a comparatively small portion of larger (“residual”) cellulose fibers may still be present in the MFC product and may therefore coexist with the microfibrillated fibrils or fibril bundles.

In the microfibrillated cellulose (“MFC”) as described throughout the present disclosure, individual fibrils or fibril bundles can be found and easily discerned by way of conventional optical microscopy, at a magnification of 40×. These fibrils and bundles of fibrils are also described as “(micro)fibrils”. In accordance with the present disclosure, any reference to “fibrils” also includes bundles of such fibrils.

In principle, any type of MFC materials can be used in accordance with the present invention, as long as the fiber bundles as present in the original cellulose pulp are sufficiently disintegrated in the process of making MFC so that the average diameter of the resulting fibers/fibrils is in the nanometer-range and therefore more surface of the overall cellulose-based material has been created, vis-à-vis the surface available in the original cellulose material. MFC may be prepared according to any of the processes known to the skilled person.

In accordance with the present invention, there is no specific restriction in regard to the origin of the cellulose, and hence of the MFC. In principle, the raw material for the cellulose microfibrils may be any cellulosic material, in particular wood, annual plants, cotton, flax, straw, ramie, bagasse (from sugar cane), suitable algae, jute, sugar beet, citrus fruits, waste from the food processing industry or energy crops or cellulose of bacterial origin or from animal origin, e.g. from tunicates.

In a preferred embodiment, wood-based materials are used as raw materials, either hardwood or softwood or both (in mixtures). Further preferably softwood is used as a raw material, either one kind or mixtures of different soft wood types.

In principle, the MFC in accordance with the present invention may be unmodified in respect to its functional groups or may be physically modified or chemically modified, or both.

Chemical modification of the surface of the cellulose microfibrils may be achieved by various possible reactions of the surface functional groups of the cellulose microfibrils and, more particularly, of the hydroxyl functional groups, preferably by: oxidation, carboxylation, carboxymethylation, silylation reactions, etherification reactions, condensations with isocyanates, alkoxylation reactions with alkylene oxides, or condensation or substitution reactions with glycidyl derivatives. Chemical modification may take place before or after the defibrillation step, preferably after the defibrillation step since the functional groups to be modified (in particular-OH groups) are sterically better available after defibrillation.

Also, the MFC is unmodified MFC or is physically modified MFC, preferably unmodified MFC. Also preferably, the MFC does not comprise a lignin coating.

“Unmodified MFC”, as referred to herein, relates to MFC that comprises only “naturally occurring functional groups”. The term “naturally occurring functional groups” refers to functional groups that are already present (or, more precisely, have already been present) when the cellulose is present in the cellulosic material from which the MFC is derived (e.g. wood, annual plants, cotton, flax, straw, ramie, bagasse (from sugar cane), suitable algae, jute, sugar beet, citrus fruits, and so on) and to functional groups that are introduced (or, more precisely, have been introduced) by means of a pulping process such as sulfite pulping or Kraft pulping.

Preferably, the MFC is derived from a pulping process and subsequent defibrillation and has not been subjected to a post-pulping chemical functionalization step. As referred to herein, a “post-pulping chemical functionalization step”, is a dedicated step of treating MFC obtained from a pulping process with another reagent in a chemical reaction such that the MFC functional groups that are present before said chemical reaction (mostly —OH groups) are converted into different functional groups. The term “dedicated” in the expression “dedicated step of treating MFC” means that the step of treating MFC is a deliberate step that is performed with the aim of modifying the functional groups. Thus, e.g., mere oxidation in ambient air over time (which occurs more or less “accidentally”) is not a chemical functionalization step within the meaning of the present application. On the other hand, oxidation by means of a dedicated treatment, e.g. an ozone treatment in an ozone generator, is a chemical functionalization step within the meaning of the present application.

In addition, the “post-pulping chemical functionalization step” (which has preferably not been applied to the MFC of the present invention) is an oxidation reaction, a carboxylation reaction, a carboxymethylation reaction, a reaction of adding cationic functional groups, and a reaction of grafting a second polymer onto the MFC.

It is also preferred that the MFC has not been subjected to a (dedicated) oxidation reaction, a carboxylation reaction, a carboxymethylation reaction, a reaction of adding cationic functional groups, and a reaction of grafting a second polymer onto the MFC.

Furthermore, the MFC has not been subjected to a chemical functionalization step after the defibrillation step. That “chemical functionalization step” is a dedicated step of treating the MFC (after the defibrillation step) with another reagent in a chemical reaction such that the MFC functional groups that are present before said chemical reaction (mostly-OH groups) are converted into different functional groups. Further preferably, the MFC has not been subjected to an oxidation reaction, a carboxylation reaction, a carboxymethylation reaction, a reaction of adding cationic functional groups, and a reaction of grafting a second polymer onto the MFC, after the defibrillation step.

The cellulose microfibrils may, in principle, also be modified by a physical route, either by adsorption at the surface, or by spraying, or by coating, or by encapsulation of the microfibril. Preferred modified microfibrils can be obtained by physical adsorption of at least one compound. The MFC may also be modified by association with an amphiphilic compound (surfactant). However, in preferred embodiments, the microfibrillated cellulose is not physically modified.

Without wishing to be bound by theory, it is believed that MFC is a highly efficient thickener in solvent systems, in particular water systems, and builds large three dimensional networks of fibrils which are stabilized by hydrogen bonds. The fibrils of MFC have hydroxyl groups on the surface that are fully dissociated (to form hydroxyl ions, O), at a high pH and cause intra and inter-particular interactions, stabilizing the overall network (stabilizing by “chemical” and/or “physical” interactions). In addition, MFC exerts high water holding capacity.

In an embodiment, the MFC is prepared or obtainable by a process, which comprises at least the following steps:
(a) subjecting a cellulose pulp to at least one mechanical pretreatment step;
(b) subjecting the mechanically pretreated cellulose pulp of step (a) to a defibrillation step, which results in fibrils and fibril bundles of reduced length and diameter vis-à-vis the cellulose fibers present in the mechanically pretreated cellulose pulp of step (a), said step (b) resulting in microfibrillated cellulose;
wherein the defibrillation step (b) involves compressing the cellulose pulp from step (a) and subjecting the cellulose pulp to a pressure drop.

The mechanical pretreatment step preferably is or comprises a refining step. The purpose of the mechanical pretreatment is to “beat” the cellulose pulp in order to increase the accessibility of the cell walls, i.e. to increase the surface area.

A refiner that is preferably used in the mechanical pretreatment step comprises at least one rotating disk. Therein, the cellulose pulp slurry is subjected to shear forces between the at least one rotating disk and at least one stationary disk.

In the defibrillation step (b), which is to be conducted after the (mechanical) pretreatment step, the cellulose pulp slurry from step (a) is passed through a homogenizer at least once, preferably at least two times, as described, for example, in PCT/EP2015/001103, the respective content of which is hereby incorporated by reference.

For example, the homogenizer may be a Microfluidics homogenizer. The defibrillation method based on the Microfluidics homogenizer may be described as the “fixed chamber” technology, that provides for a longer pathway and therefore less sudden impact on the pulp fibers. In the Microfluidics homogenizer, fibrillation of the cellulose fibers occurs by passing the cellulose fibers through homogenization chambers or valves.

In particular, in the Microfluidics homogenizer, as it is usually used in the art for fiber defibrillation, the cellulose fiber suspension is subjected to a pressure differential by passing through Z-and/or Y-shaped channels, which are arranged within a chamber. The cellulose fiber suspension is typically passed through at least two Z- and/or Y-shaped channels with various diameters that are connected in series, firstly, typically one Z- or Y-shaped channel with a large diameter (for example 400 μm) and secondly, one Z- or Y-shaped channel with a small diameter (for example 100-200 μm) to avoid clogging of the smaller channels. The defibrillation of the cellulose fibers to fibrils and/or fibril bundles is achieved because of the pressure differential due to the small diameter in the channels and the turbulence created within the channels.

Obtained by using a Microfluidics homogenizer or, in general, the “fixed chamber” technology, comprises no or very little bifurcation of fibril ends.

In particular, essentially all of the larger fibrils, fibril bundles and fiber residuals (above approximately 40 micron in length), of the MFC as manufactured in a Microfluidics homogenizer and as viewed in an optical microscope at a magnification of 40× or 100× terminate in cleanly cut-off endpoints, in both fibril/fiber ends. The fibril bundles/fibrils of shorter length have predominantly non-bifurcated ends. Only a very few of these endpoints are bifurcated into smaller diameter (secondary) fibrils, and if bifurcated, only a low amount of bifurcations, typically one or two, is present. Even fewer, if any, of these endpoints are highly bifurcated into “brush-like” end structures.

“Bifurcation” of fibril ends should be understood as the pattern at the end of a main fibril with brush like appearance of smaller fibrils being partly released at one or two of the end points of a main fibril, but still being attached to the main core fibril.

According to an embodiment, the MFC comprises fibril bundles and/or individual fibers, wherein at least a fraction of the fibril bundles and/or individual fibrils of the MFC has bifurcations on at least one end of the main fibrils into secondary fibrils, preferably bifurcations into three or more secondary fibrils, further preferably bifurcations into four or five or more secondary fibrils, wherein said secondary fibrils have a smaller diameter than the non-bifurcated main fibril.

In particular, in such “bifurcated MFC”, a significant part of the fibrils or fibril bundles of the MFC, as discernible in optical microscopy at a magnification of 40 times (or, in 100 times), does not terminate in an end point, but the “main” fibril rather bifurcates at this end point, at least once, preferably two or more times, further preferably three or more times, further preferably five or more times into secondary fibril segments of a smaller diameter than the “main” fibril.

Preferably, the number of said bifurcated ends of fibrils/fibril bundles is at least 60 bifurcated ends of fibrils per mm², as measured in accordance with the optical light microscopy method as described herein, at a magnification of 40 times, preferably at least 80 bifurcated ends of fibrils per mm², further preferably at least 100 bifurcated ends of fibrils per mm².

Also preferably, the ratio of the number of bifurcated ends of fibrils/fibril bundles of the MFC relative to the number of bifurcated ends of fibrils/fibril bundles of a reference MFC, that has been homogenized in a conventional Microfluidics homogenizer, as described herein, is at least 5, preferably at least 10, further preferably at least 15, wherein the number of bifurcated ends of fibrils/fibril bundles is measured in accordance with the optical light microscopy method as described herein, at a magnification of 40 times.

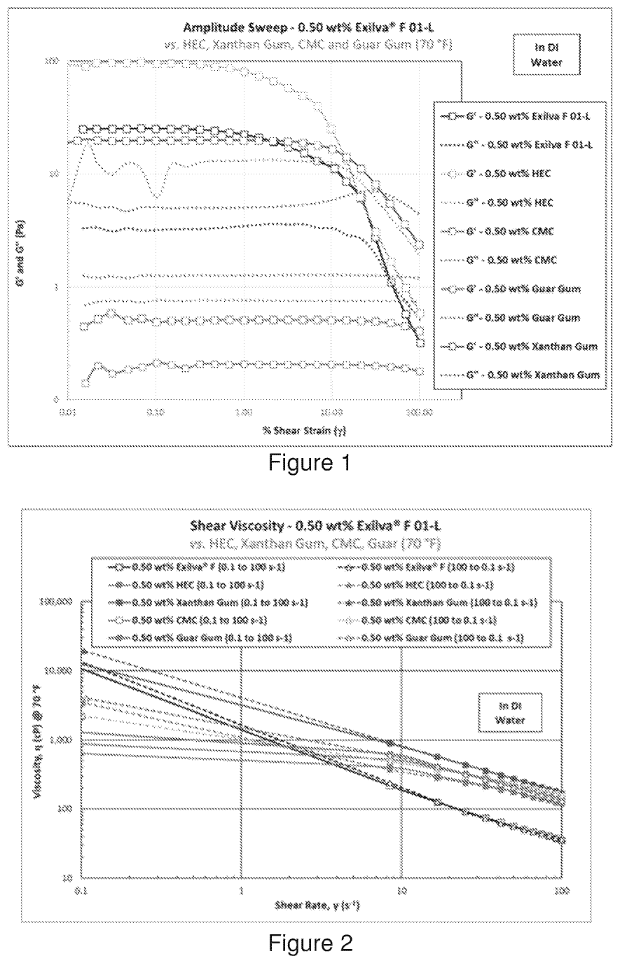

The dispersant, e.g. microfibrillated cellulose, may be a MFC product as marketed by Borregaard Chemicals Company under the trademark of Exilva™. This MFC has a greater storage capacity (Table 1 and FIG. 1) and greater slope of viscosity over shear rate (Table 2 and FIG. 2) as compared to common gelling agents.

More specifically, Table 1 and FIG. 1 show the results of an amplitude sweep test for 0.5 wt % Exilva™ MFC in tap water at ambient temperature, compared to the same amount of other cellulose or polysaccharide derivatives including HEC, CMC, guar gum and xanthan gum. In the amplitude sweep from 0 to 100%, the amplitude of the deformation is varied while the frequency is kept constant, and the storage modulus G′ and the loss modulus G″ are plotted against the deformation. In general, gelling agents are essentially polymeric materials with complex viscoelastic characteristics. At G′/G″ ratio of 1, it indicates an equal contribution by the storage (elastic) and loss (viscous) modulus respectively. MFC distinguishes itself against other common gelling agents with a significantly greater G′/G″ ratio, exhibiting superior elastic feature that is fundamental to its uniquely strong dispersing capability associated with this invention. In particular, the 3.5 (vs HEC) and 10.6 (vs CMC) folds increases in the G′/G″ ratio over two commonly used cellulose analogues demonstrate the distinctive feature of MFC material routed in its un-modified chemical nature and aspect ratio ranges.

TABLE 1

| Species | MFC | Xanthan | HEC | Guar | CMC |
|---|---|---|---|---|---|
| G′/G″ | 3.08 | 1.56 | 0.88 | 0.37 | 0.29 |

Table 2 and FIG. 2 show the results of a shear viscosity test for the same components as those of FIG. 1, depicting viscosity against shear rate where the slope of viscosity over shear rate is greatest for MFC compared to other common gelling agents. This is advantageous in providing a treatment composition, e.g. a stimulating composition, with beneficial shear thinning and fluid loss properties, amongst others.

TABLE 2

| Species | MFC | Xanthan | Guar | HEC | CMC |
|---|---|---|---|---|---|
| Slope | 7.14 | 3.22 | 2.04 | 1.92 | 1.64 |

A number of potential advantages of the present invention are discussed herein, although a person of skill in the art will appreciate that there may be others.

One advantage is that the present composition may be a shear thinning fluid (that is, the viscosity of the fluid decreases with rate of shear). This allows the treatment composition, e.g. stimulating fluid, to be pumped through the wellbore with little or no friction resistance, and while at slower pumping rates or near static conditions, the fluid exerts sufficient viscosity to preserve a single phase without undesirable phase separation.

Another potential advantage is that the composition may not leave undesirable residues in the formation as all additives are fully dispersible.

Another potential advantage of the composition is that it may exhibit beneficial fluid loss control. Such fluid loss control may be useful, among other instances, when an acidic treatment fluid is being used in a fracturing application, in particular where abundant natural fracture network exists. This may be due at least in part to the microcellulose fiber's potential to leak off into formation due to its superior shear thinning performances.

Another potential advantage may include ease of mixing over other commonly used gelling agents (thus avoiding lumping and thus not requiring pH adjustment for polymer dispersion), potential capability of dispersing in any brine over a wider range of pH levels, potential relative ease of additive hydration in the presence of certain common contaminants, potential capability of compatibility with formation brine (potentially saving time and cost), and potential ability to be directly blended into a mineral acid.

In a first embodiment, the hydrogen sulfide scavenger comprises or consists of a lignosulfonate or a modified lignosulfonate, e.g. a lignosulfonate metal salt.

Lignosulfonates are generated as a by-product of the sulfite pulping process of wood, during which, the “infinite” lignin network is broken down and sulfonate groups are introduced on the lignin. The transformed lignin is hence rendered water-soluble and can be separated from the cellulosic fibers and material. Lignin isolated by a different process may alternatively be sulfonated post-separation, e.g., as sulfonated or sulfomethylated Kraft, soda or hydrolysis lignin. The original lignin structure is preserved to a certain degree, which endows lignosulfonates with its amphiphilic features. In technical applications, lignosulfonates are usually found as the polyelectrolyte salt of the lignosulfonic acid. Anionic groups such as sulfonate and carboxylic groups ensure water solubility, while less polar groups, i.e., aromatic and aliphatic moieties, facilitate interactions with surfaces and interfaces. Due to their surface activity, lignosulfonates can be generally considered surfactants. However, their structure is lacking the common one-dimensional hydrophilic-head hydrophobic-tails configuration as evident in simpler surfactants. Given their poly-branched three-dimensional geometry, it comes to no surprise that lignosulfonates are frequently exploited as high potent multiple-functional surfactants, dispersants and chelating agents to metal cations.

Since most applications for lignosulfonates are in aqueous phase, which makes hydrophilicity a necessary feature. Still, the hydrophobic property of lignosulfonates facilitates interactions with a second non-aqueous phase. The end-use therefore relies on the appropriate balance of the hydrophobic and hydrophilic property, which are in turn dictated by the chemical composition and structure. Tailoring platform and specialty chemicals from lignin by controlling the separation process and by various post-separation chemical modification schemes that yielded more specialized lignosulfonate products reflected by a broader range of products on the hydrophobic scales. Aqueous-phase behavior, such as conformation, self-association, and adsorption, is strongly linked to the chemical composition and structure of the lignosulfonate surfactant.

Lignosulfonates are generally regarded as randomly branched polyaromatic polyelectrolytes, which exhibit water-solubility and surfactant-like behavior. Hydrophilicity is imparted by the presence of anionic sulfonate groups, but also to a less extent by anionic carboxylate groups and phenolic hydroxyl groups. The counterion is often a remnant from the pulping process, such as sodium, calcium, magnesium, or ammonia, which facilitates dissociation in aqueous solution. Apart from the dissociation equilibrium, the counterion may otherwise determine the physicochemical properties of lignosulfonates, for example by affecting the polymer conformation. Some of the polar functional groups, i.e., ketones, aldehydes, and methoxy groups, are not operative hydrophilic groups. Aliphatic hydroxyl and ether groups can be intrinsically hydrophilic; however, their functionality is determined by the surrounding molecular structure.

The molecular weight is furthermore an important factor determining the properties and behavior of lignosulfonates. For example, high molecular weight may cause stearic shielding of certain moieties, while the degree of sulfonation is typically decreased with increasing molecular weight. The molecular weight is naturally linked to the molecular dimensions and the diffusion coefficient, which can further affect interfacial adsorption and related phenomena. Overall, lignosulfonates may span from less than 1000 Daltons to more than 400,000 Daltons in molecular weight. Typically, the molecular weight distribution of the pure hardwood samples is consistently lower than that of lignosulfonates with softwood origin. This characteristic is likely resulting from the compositional differences of hardwood and softwood, which may furthermore determine the properties of the lignosulfonate product. It is believed that most lignosulfonate molecules present themselves in an oblate spheroid shape in aqueous medium.

As mentioned above, lignosulfonates are typically formed as by-products from the production of wood pulp using sulfite pulping.

Lignosulfonates may typically be aqueous soluble anionic polymers, and may have generally a wide molecular weight distribution, typically in the range of about 500 to about 200,000 Daltons.

The hydrogen sulfide scavenger, e.g. lignosulfonate, may be present at a concentration of about 0.01-75 wt %, e.g. about 0.05-60 wt %, typically about 0.1-50 wt %, based on the total weight of the composition. It will be understood that the concentration of the hydrogen sulfide scavenger in the composition may be selected based on the particular use and conditions, for example based on rock type or lithology, formation temperature.

Advantageously, the use of a lignosulfonate may allow the use of an environmentally-friendly material which is sustainable and biodegradable.

Lignosulfonates appropriate for the purpose of acting as a rate modulator can be defined by the extent of derivation from the lignin starting material, essentially a degree of sulfonation parameter as depicted in formula (3):

$$DS = \frac{{N}_{NaOH} {V}_{NaOH}}{{W}_{LS}} \qquad ( 3 )$$

where DS is the degree of sulfonation (mmol/g), N_{NaOH} the mole concentration of the NaOH standard solution (mmol/ml) used in the titration, consumed by a volume of V_{NaOH} (ml), W_{LS} the mass of the lignosulfonate material (g) used to make up the titration solution.

The DS value is typically estimated by first passing the lignosulfonate solution of known weight concentration through, in sequence, an anion exchange resin column for the purpose of removing residue inorganic acid, and a cation exchange resin column to converting lignosulfonate into corresponding lignosulfonic acid. The resultant acidic solution is then titrated by a sodium hydroxide standard solution, with the equivalence point being monitored by a potentiometer. The appropriate DS values are typically ranging from about 0.2 to about 5.0, such as from about 0.5 to about 4.0, for example, from about 0.8 to about 3.5.

Modified lignosulfonate may comprise or may consist of alkylated lignosulfonate.

Modified lignosulfonate may include lignosulfonates reacted with a base or salt.

In an embodiment, the hydrogen sulfide scavenger may comprise or may consist of a metal lignosulfonate. Preferably, the metal may be a metal cation such as polyvalent or monovalent metal cation. The metal lignosulfonate may comprise one or more cations selected from the group consisting of calcium, magnesium, zinc, iron, copper, cobalt, manganese, nickel, titanium, aluminum, or combinations thereof.

In some embodiments, the hydrogen sulfide scavenger may comprise or may consist of a transition metal lignosulfonate.

In a second embodiment, the hydrogen sulfide scavenger comprises or consists of a metal organic framework (MOF).

Metal organic frameworks are a type of coordination polymer having extended three-dimensional framework structures formed from extended chains, sheets or networks of metal ions interconnected by ligands or linkers.

The term metal organic framework, or “MOF” or “porous MOF”, refer, for example, to a 3-dimensional micro or nano porous metal organic framework material comprising at least one bidentate organic compound having a coordinate bond to at least one metal ion. Suitable MOFs for the applications and methods of the present disclosure comprise a plurality of micro and/or nano pores having a plurality of accessible sites for the reversible uptake of one or more target chemical entities. Examples of suitable MOFs are disclosed in U.S. Pat. Nos. 7,202,385, 7,880,026, 8,133,301, 8,269,029, 8,322,534 and U.S. Patent Application Publication Nos. 2012/0085235, 2012/0296095, 2012/0115961, 2012/0259117, and 2011/0319604, the contents of which are hereby incorporated by reference in their entireties.

The MOFs, such as porous MOFs comprising a plurality of accessible micro and/or nano pores, and/or composite MOFs (loaded MOFs coated with a polymeric material, such as an inter-polymer complex), may be loaded with a hydrogen sulfide scavenger, such as a target metal lignosulfonate species that can reversibly associate with the MOF.

The plurality of pores of the porous MOF may include micropores and/or mesopores. “Micropores” are defined as those having a diameter of about 2 nm or less, such as a diameter in the range of from about 2 nm to about 0.01 nm, or a diameter in the range of from about 1 nm to about 0.1 nm; and “mesopores” are defined by a diameter in the range of from about 2 to about 50 nm, such as a diameter in the range of from about 5 nm to about 40 nm, or a diameter in the range of from about 10 nm to about 30 nm, in each case according to the definition as stated in Pure Applied Chem. 45, page 71, in particular on page 79 (1976). The presence of micropores and/or mesopores can be checked with the aid of sorption measurements, these measurements determining the absorptivity of the MOF for nitrogen at 77 Kelvin according to DIN 66135, DIN 66131 and/or DIN 66134. In embodiments, the specific surface area, calculated using the Langmuir model according to DIN 66135 (DIN 66131, 66134) for a MOF in powder form, may be from about 500 m²/g to about 15,000 m²/g, or from about 1,500 m²/g to about 12,000 m²/g, or from about 2,500 m²/g to about 10,000 m²/g.

The metal in the MOF framework may be any appropriate metal that is capable of forming a porous MOF that possesses a structure allowing for the reversible loading of an effective amount of the target chemical entity, such as, for example, a crosslinker, a breaker, or an acidizing agent, for the desired downhole application. For example, the metal may be selected from one of the known metal containing groups of the periodic table, such as groups Ia, IIa, IIia, IVa to VIIa and Ib to VIb of the periodic table, including metals such as, for example, Mg, Ca, Sr, Ba, Sc, Y, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, Hg, Al, Ga, In, Ti, Si, Ge, Sn, Pb, As, Sb and Bi. Ionic states of the above metals may include, for example, Mg²⁺, Ca²⁺, Sr²⁺, Ba²⁺, Sc³⁺, Y³⁺, Ti⁴⁺, Zr⁴⁺, HF⁴⁺, V⁴⁺, V³⁺, V²⁺, Nb³⁺, Ta³⁺, Cr³⁺, Mo³⁺, W³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni+, Pd²⁺, Pd⁺, Pt²⁺, Pt⁺, Cu²⁺, Cu⁺, Ag⁺, Aut, Zn²⁺, Cd²⁺, Hg²⁺, Al³⁺, Ga³⁺, In³⁺, Ti³⁺, Si⁴⁺, Si²⁺, Ge⁴⁺, Ge²⁺, Sn⁴⁺, Sn²⁺, Pb⁴⁺, Pb²⁺, As⁵⁺, As³⁺, Ast, Sb⁵⁺, Sb³⁺, Sb+, Bi⁵⁺, Bi³⁺and Bi⁺.

The phrase “at least one bidentate organic compound” refers to an organic compound that comprises at least one functional group that is capable of forming at least two bonds, such as two coordinate bonds, to a given metal ion and/or one coordinate bond to two or more metal atoms.

For example, the following functional groups may be suitable functional groups via which the coordinate bonds can be formed: —CO₂H, —CS₂, —NO₂, —B(OH)₂, —SO₃H, —Si(OH)₃, —Ge(OH)₃, —Sn(OH)₃, —Si(SH)₄, —Ge (SH)₄, —Sn(SH)₃, —PO₃H, —AsO₃H, —AsO₄H, —P(SH)₃, —As(SH)₃, —CH(RSH)₂, —C(RSH)₃, —CH(RNH₂)₂, —(RNH₂) ₃, —CH(ROH)₂, —C (ROH)₃, —CH(RCN)₂, —C(RCN)₃, where R is, for example, an alkylene group having 1, 2, 3, 4 or 5 carbon atoms, such as, for example, a methylene, ethylene, n-propylene, isopropylene, n-butylene, isobutylene, tert-butylene or n-pentylene group, or an aryl group comprising one or two aromatic nuclei, such as, for example, two Ce rings which may be condensed and, independently of one another, may be suitably substituted by at least one substituent in each case, and/or, independently of one another, may comprise in each case at least one hetero atom, such as, for example, N, O and/or S. In embodiments, functional groups in which the above-mentioned radical R is not present may also be suitable, such as, for example, —CH(SH)₂, —C(SH)₃, —CH(NH₂)₂, —C (NH₂)₃, —CH(OH)₂, —C(OH)₃, —CH(CN)₂ or —C(CN)₃.

The at least one functional group may be bonded to any suitable organic compound, provided that the organic compound having this functional group is capable of forming the coordinate bond(s) and of producing a porous MOF that is stable (thermally and chemically) in the presence of an effective amount of the target chemical entity for the desired downhole application or function such as hydrogen sulfide scavenger. In addition, the MOF cavities can themselves been functional to store hydrogen sulfide molecules via interacting mode of either physical trapping or electrostatic binding.

In this and the follow up embodiments, the at least one bidentate organic compound may be an organic compound that comprises at least two functional groups. The at least two functional groups may be bonded to any suitable organic compound, provided that the organic compound having these functional groups is capable of forming the coordinate bond and of producing a porous MOF that is stable (thermally and chemically) in the presence of an effective amount of the target chemical entity (such as, for example, a crosslinker, a breaker, acid, base, or an acidizing agent) and in the intended downhole environment (for example, the surrounding chemicals and the phase thereof, including pH, ionic strength, temperature, pressure, etc.,) for the desired downhole application. In embodiments, the porous MOFs (and/or the porous MOFs loaded with the target hydrogen sulfide scavenger) may be stable (for example, less than 2% by mass deterioration or decomposition, or less than 1% by mass deterioration or decomposition) in air, aqueous and/or organic solvents (even at the pH ranges discussed below), and/or downhole conditions (such as, for example, temperature or pressure) or downhole environment (such as for example, the surrounding chemicals and the phase thereof, including pH, ionic strength, temperature, pressure, etc.), for periods greater than a week, such as periods from a about a week to multiple years, such as from about a month to about a year. In embodiments, the porous MOFs (and/or the porous MOFs loaded with hydrogen sulfide scavenger) may be stable (for example, less than 2% by mass deterioration or decomposition, or less than 1% by mass deterioration or decomposition) for periods greater than a month, or greater than 18 months.

In embodiments, the organic compounds that comprise the at least one functional group (or the at least two functional groups) may be derived from a saturated aliphatic compound, an unsaturated aliphatic compound, an aromatic compound, or a compound that is both aliphatic and aromatic. The aliphatic compound (or the aliphatic moiety of the compound that is both aliphatic and aromatic) may be linear and/or branched and/or cyclic. For example, the aliphatic compound (or the aliphatic moiety of the compound which is both aliphatic and aromatic) may comprise from 1 to about 15 carbon atoms, such as from about 2 to about 14 carbon atoms, or from about 3 to about 12 carbon atoms.

The aromatic compound or the aromatic moiety of the compound that is both aromatic and aliphatic may have one or more rings, such as, for example, two, three, four or five rings. Such rings may be separated from one another and/or be present in fused form.

Independently of one another, each ring may comprise at least one hetero atom, such as, for example, N, O, S, B, P, Si or Al.

In embodiments, the at least one bidentate organic compound may be a dicarboxylic acid, a tricarboxylic acid, tetracarboxylic acid, or an imidazole or other derivatives of amine(s).

Suitable dicarboxylic acids may include, for example, oxalic acid, succinic acid, tartaric acid, 1,4-butanedicarboxylic acid, 4-oxopyran-2,6-dicarboxylic acid, 1,6-hexanedicarboxylic acid, decanedicarboxylic acid, 1,8-heptadecanedicarboxylic acid, heptadecanedicarboxylic acid, 1,9-heptadecanedicarboxylic acid, acetylenedicarboxylic acid, 1,2-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenyl ethane-3,3′-dicarboxylic acid, quinoline-3,4-dicarboxylic acid, 7-chloro-4-hydroxyquinoline-2,8-dicarboxylic acid, diimidodicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octadicarboxylic acid, pentane-3,3-carboxylic acid, 4,4′-diamino-1,-diphenyl-3,3′-dicarboxylic acid, 4,4′-diaminodiphenyl-3, 3 ‘-dicarboxylic acid, benzidene-3,3’-dicarboxylic acid, 1,4-bis(phenylamino) benzene-2,5-dicarboxylic acid, 1,-dinaphthyl-5,5′-dicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazoline-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, O-hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, 4,4′-diaminodiphenyl ether diimidodicarboxylic acid, 4,4′-diaminodiphenylmethanediimidodicarboxylic acid, 4,4′-diaminodiphenyl sulfone diimidodicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, diphenyl ether 4,4′-dicarboxylic acid, imidazole-4,5-dicarboxylic acid, 4 (1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatricontanedicarboxylic acid, tetradecanedicarboxylic acid, 1,7-heptadicarboxylic acid, 5-hydroxy-1,3-benzenedicarboxylic acid, pyrazine-2,3-dicarboxylic acid, furan-2,5-dicarboxylic acid, I-nonene-6,9-dicarboxylic acid, eicosenedicarboxylic acid, 4,4′-dihydroxydiphenylmethane-3,3′-dicarboxylic acid, 1-amino-4-methyl-9, 10-dioxo-9,10-dihydroanthracene-2,3-dicarboxylic acid, 2,5-pyridinedicarboxylic acid, cyclohexene-2,3-dicarboxylic acid, 2,9-dichlorofluoroubin-4,11-dicarboxylic acid, 7-chloro-3-mnethylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid or salts thereof.

Suitable tricarboxylic acids may include, for example, 2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphon-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurinetricarboxylic acid.

Suitable tetracarboxylic acids may include, for example, 1,1-dioxoperylo [1,12-BCD]thiophene-3,4,9,10-tetracarboxylic acid, perylene-tetracarboxylic acids, such as perylene-3,4,9, 10-tetracarboxylic acid or perylene-1,12-sulfonyl-3,4,9,10-tetracarboxylic acid, butanetetracarboxylic acids, such as 1,2,3,4-butanetetracarboxylic acid or meso-1,2,3,4-butanetetracarboxylic acid, decane-2,4,6,8-tetracarboxylic acid, 1,4,7,10, 13,16-hexaoxacyclooctadecane-2,3, 11, 12-tetracarboxylic acid, 1,2,4,5-benzenetetracarboxylic acid, 1,2,11, 12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids, such as cyclopentane-1,2,3,4-tetracarboxylic acid.

In addition to these at least bidentate organic compounds, the MOF may also comprise one or more monodentate ligands.

Further metal ions, polydentate organic compounds and solvents for the preparation of porous MOFs may be found in U.S. Pat. No. 5,648,508, the disclosure of which is hereby incorporated by reference in its entirety.

In embodiments, the at least one bidentate organic compound or ligands are selected to form a porous MOF having pores, cages and/or channels of a predetermined size and shape, such that the functional groups of the porous MOF(s) may be selected to non-covalently interact with the functional groups of a preselected target hydrogen sulfide scavenger for the desired downhole application. In embodiments, specific bidentate organic compounds or ligands may be selected and/or further functionalized such that functional groups line the cages and channels, and/or the pores.

Functional groups that may be present (or added) to the MOF and/or the target chemical entity include, for example, halogens, alcohols, ethers, ketones, carboxylic acids, esters, carbonates, amines, amides, imines, ureas, aldehydes, isocyanates, tosylates, alkanes, alkenes, alkynes, or combinations thereof.

In embodiments, specific building blocks may be selected and/or further functionalized such that a desired MOF structure with a predetermined pore size is obtained. Generally, the larger the molecular size of the at least one bidentate organic compound or other ligands, the larger the pore size of the MOF. Such porous MOF(s) of the present disclosure may also be selected such that when they are exposed to downhole conditions (such as, for example, temperature or pressure) or a downhole environment (such as for example, the surrounding chemicals and the phase thereof, including pH, ionic strength, temperature, pressure, etc.,), an effective amount of the target chemical entity for the desired downhole application is desorbed (or released) from the porous MOF(s).

In embodiments, the pore size of the porous MOF may be controlled by the choice of the suitable ligand and/or of the at least one bidentate organic compound, such that the average pore size is in a range of from about 0.1 nm to about 75 nm, or an average pore size in a range of from about 0.5 nm to about 10 nm, or an average pore size in a range of from about 1.0 nm to about 5 nm.

In embodiments, the pore volume of the unit cell of the MOF is uniform throughout the MOF, such that the distribution of pore volume across the entire MOF particle or composition is uniform and the pore size is monodisperse. For example, the MOFs used in the methods of present disclosure may be MOFs that contain a single pore size, such as a single pore size that falls in a range of from about 0.1 nm to about 75 nm, or a single pore size that falls in a range of from about 0.5 nm to about 10 nm, or a single pore size that falls in a range of from about 1.0 nm to about 5 nm.

In some embodiments, the MOF may contain a distribution of pore sizes. In such embodiments, the MOFs used in the methods of present disclosure may be MOFs in which more than 70% of the total MOF pore volume, such as more than 85%, or more than 99%, is formed by pores having a pore diameter less than 100 nm, such as less than 50 nm or less than 40 nm. In embodiments, no more than 5% of the total MOF pore volume, such as more than 2% of the total pore volume, or more than 0.5% of the total pore volume is formed by empty pores having a pore diameter greater than 50 nm, or greater than 100 nm or greater than 200 nm.

The porous MOFs suitable for use in the methods of the disclosure may comprise one or more of the following characteristics: a surface area (Langmuir surface area) of the plurality of pores is greater than about 500 m²/g; a surface area of the plurality of pores may be from about 500 to about 15,000 m²/g, or a surface area of the plurality of pores may be from about 1,000 to about 10,000 m²/g, or surface area of the plurality of pores may be from about 2,000 to about 6,000 m²/g; an average pore volume of the plurality of pores comprising the porous MOF is in the range from about 0.005 to about 15 cm³/g, such as from about 0.05 to about 5 cm³/g; and the framework of the porous MOF has a density in a range of from about 0.03 to about 5 g/cm³, or from about 0.3 to about 1.5 g/cm³

In embodiments, the porous MOFs comprise a thermal stability range (in which it will not decompose, or less than 2% by mass deterioration or decomposition, such as less than 1% by mass deterioration or decomposition) of at least 10° C. higher than the highest temperature that is observed in the subterranean formation being treated, such as a thermal stability range of at least up to 200° C., or a thermal stability range of greater than about 60° C. to about 200° C., or a thermal stability range of greater than from about 80° C. to about 190° C., or a thermal stability range of greater than from about 100° C. to about 180° C. In embodiments, the porous MOFs may be selected to have chemical (and thermal) stability (in which it will not decompose, or less than 2% by mass deterioration or decomposition, such as less than 1% by mass deterioration or decomposition) that is sufficient to survive downhole chemical environments for periods greater than a week, such as periods greater than a month, or greater than 6 months. In embodiments, the porous MOFs may comprise a pressure stability range of at least 100 psi higher than the highest pressure that is observed in the subterranean formation being treated, such as a pressure stability range of greater than about 3,000 psi to about 25,000 psi, or a pressure stability range of greater than from about 4,000 psi to about 6,000 psi. In embodiments, the porous MOFs comprise a pH stability range of from about −1 to about 15, or a pH stability range of from about 5 to about 10, or a pH stability range of from about 6 to about 8.5. In embodiments, the porous MOFs may stable at a pH in the range of from about −1 to about 3, such as a pH in the range of from 0.1 to about 2. In embodiments, the porous MOFs may stable at a pH in the range of from about 9 to about 15, such as a pH in the range of from 10 to about 12. The porous MOFs may stable (for example, less than 2% by mass deterioration or decomposition, or less than 1% by mass deterioration or decomposition) at such pH values for periods greater than a week, such as periods greater than a month, or greater than 18 months.

In a third embodiment, the hydrogen sulfide scavenger comprises or consists of a metal lignosulfonate encapsulated in a metal organic framework (MOF).

In a fourth embodiment, the hydrogen sulfide scavenger comprises or consists of a metal salt encapsulated in a metal organic framework (MOF).

In a fifth embodiment, the hydrogen sulfide scavenger comprises or consists of a metal salt.

The hydrogen sulfide scavenger may comprise or may consist of a metal cation such as a polyvalent or monovalent metal cation, e.g. one or more cations selected from the group consisting of calcium, magnesium, zinc, iron, copper, cobalt, manganese, nickel, titanium, aluminum, or combinations thereof, and/or from a transition metal cation.

In a sixth embodiment, the hydrogen sulfide scavenger comprises or consists of a triazine compound.

The hydrogen sulfide scavenger may comprise or may consist of a triazine compound made from monoethanolamine (MEA) or methylamine (MA).

The hydrogen sulfide scavenger may comprise one or more triazine compounds selected from the list consisting of hexahydro-1,3,5-tris(hydroxyethyl)-s-triazine, 1,3,5-Trimethyl-1,3,5-triazinane, 1,3-diisocyanaomethylbenzene, 1,3,5-Triazine-1,3,5-trimethanol, 1,3,5-triacryloylaminohexahydro-s-triazine, 1,3,5-Tris(2-hydroxyethyl)-13,5-triazine-2,4,6-trione, 1,3,5-Triazine-1-carboxylic acid, tetrahydro-3,5-bis(1-oxo-2-propen-1-yl), 1,3,5-Tris[(dimethylamino)ethyl]hexahydrotriazine, 1,3,5-Tri(m-trifluoromethylphenyl) hexahydrotriazine, Benzamine-4,4′,4″-(1,3,5-tri)tri[N, N-diphenyl-(9Cl)], hexahydro-1,3,5-tris(2-methoxyphenyl)-1,3,5-triazine, 1,3,5-Tris(2,3-dibromopropyl)-2,4,6-trioxohexahydro-s-triazine, and 2,4,6-Trihydroxy-1,3,5-triazine.

The composition may comprise or may further comprise a base fluid, preferably an aqueous base fluid. The base fluid may comprise fresh water, salt water, seawater, a brine (e.g., a saturated salt-water brine or a formation brine), or a combination thereof.

It will be understood that other aqueous fluids may be used as the base fluid, including aqueous solutions comprising monovalent, divalent, or trivalent cations (e.g., magnesium, calcium, zinc, or iron). If a water source is used that contains such divalent or trivalent cations in concentrations sufficiently high to be problematic, then such divalent or trivalent salts may be removed, for example by a process such as reverse osmosis, or by raising the pH of the water in order to precipitate out such divalent salts to lower the concentration of such salts in the water before the water is used. Another method may include adding a chelating agent to chemically bind the undesirable ions. Suitable chelants include, but are not limited to, citric acid or sodium citrate, ethylenediaminetetraacetic acid (“EDTA”), hydroxyethylethylenediaminetriacetic acid (“HEDTA”), dicarboxymethyl glutamic acid tetrasodium salt (“GLDA”), diethylenetriaminepentaacetic acid (“DTPA”), propylenediaminetetraacetic acid (“PDTA”), ethylenediaminedi (o-hydroxyphenylacetic) acid (“EDDHA”), glucoheptonic acid, gluconic acid, and the like, and nitrilotriacetic acid (“NTA”). Other chelating agents also may be suitable. One skilled in the art will readily recognize that an aqueous base fluid containing a high level of multi-valent ions should be tested for compatibility prior to use.

The choice of aqueous base fluid and acid may be selected vis-a-vis the other, among other reasons, so that the proper synergistic effect is achieved.

The composition may comprise one or more additives.

The composition may comprise a fluid loss additive. Whilst the inventors have discovered that the presence of microfibrillated cellulose in the composition may provide advantageous fluid loss properties to the composition, it may be desirable in some instances to include one or more fluid loss additives in order to fine tune the properties of the composition.

Advantageously, a fluid loss additive may be selected to be compatible with the composition, e.g. stimulation composition, of the present invention.

The fluid loss additive may comprise one or more compounds selected from the list consisting of starches, silica flour, and diesel dispersed in a fluid.

The fluid loss additive may comprise a degradable material, which may include one or more compounds, e.g. polymers, selected from the list consisting of polysaccharides such as dextran or cellulose; chitins; chitosans; proteins; aliphatic polyesters; poly(lactides); poly(glycolides); poly(glycolide-co-lactides); poly(ε-caprolactones); poly(3-hydroxybutyrates); poly(3-hydroxybutyrate-co-hydroxyvalerates); poly(anhydrides); aliphatic poly(carbonates); poly(orthoesters); poly(amino acids); poly(ethylene oxides); poly(phosphazenes); derivatives thereof; or combinations thereof.

The fluid loss additive may be present in the composition at a concentration of about 5 to 100 pounds per 1000 gallons, e.g. about 10 to about 50 pounds per 1000 gallons, of the composition.

### EXAMPLES

### Example 1: H₂S Scavenging tests

Five stock solutions were prepared as follows:
1. A stock solution containing:
   zinc lignosulfonate (12.5 wt % active zinc, Borregaard) 1.57 g=2.9 mM zinc, and
   microfibrillated cellulose (10% active aqueous paste, Borregaard) 2.0 g dissolved in 6.43 g tap water;
2. A stock solution containing:
   zinc lignosulfonate (12.5% active zinc, Borregaard) 1.57 g=2.9 mM zinc, dissolved in 8.43 g tap water;
3. A stock solution containing:
   zinc chloride (SigmaAldrich, reagent grade, >98%) 0.40 g=2.9 mM, and
   microfibrillated cellulose (10% active aqueous paste, Borregaard) 2.0 g, dissolved in 7.60 g tap water;
4. A stock solution containing:
   iron lignosulfonate (20% active Fe (II), Borregaard) 0.81 g=2.9 mM iron, and
   microfibrillated cellulose (10% active aqueous paste, Borregaard) 2.0 g, dissolved in 7.19 g tap water;
5. A stock solution containing iron lignosulfonate (20% active Fe (II), Borregaard) 0.81 g=2.9 mM iron, dissolved in 9.19 g tap water.

The tests described in Table 3 below were conducted in a well vented fumehood, where a sodium sulfide nonahydrate (SigmaAldrich, ACS grade, >98% purity) 70 mg was weighted on a scale and dissolved in 100 g tap water (pH˜10.5), equivalent to 0.29 mMol of H₂S, ie. 100 ppm, in a beaker placed on a hot plate under moderate agitation by a magnetic stirring bar. A strip of lead acetate tape (SigmaAldrich) inserted into the solution was turned from white into dark brown instantly, indicating the presence of sulfide anion forming lead sulfide of characteristic dark brown coloration.

The tests were conducted by adding increasingly larger aliquots of the respective stock solution into the sulfide-containing solution under moderate agitation whiling observing the coloration of the lead acetate tape inserted at the end of each stage. The resulting coloration trends on the lead acetate tape and also observation in the resultant static fluid mixture phase change are summarized in Table 3 below:

TABLE 3

| | 0 ml | 0.25 ml | 0.50 ml | 0.75 ml | 1.00 ml | |
|---|---|---|---|---|---|---|
| | Aliquot | Aliquot | Aliquot | Aliquot | Aliquot | |
| | PbAc | PbAc | PbAc | PbAc | PbAc | Fluid |
| | Tape | Tape | Tape | Tape | Tape | Phase |
| ID | Coloration | Coloration | Coloration | Coloration | Coloration | Change |
| Stock | Black | Dark | Intense | Light | Original | Whiteish fluid |
| solution | | brown | brown | Brown | white | remains single |
| 1 | | | | | | phase |
| Stock | Black | Dark | Intense | Light | Original | Whiteish fluid |
| solution | | brown | brown | Brown | white | starts to appear |
| 2 | | | | | | cloudy |
| Stock | Black | Dark | Intense | Light | Original | Whiteish fluid |
| solution | | brown | brown | Brown | white | remains single |
| 3 | | | | | | phase |
| Stock | Black | Dark | Intense | Light | Original | Blackish fluid |
| solution | | brown | brown | Brown | white | remains single |
| 4 | | | | | | phase |
| Stock | Black | Dark | Intense | Light | Original | Blackish fluid |
| solution | | brown | brown | Brown | white | starts to appear |
| 5 | | | | | | cloudy |

When the stock solution aliquot was under 0.75 mL, the color change on the lead acetate tape was increasingly lighter, demonstrating the rapid scavenging of sulfide anion at the stoichiometric ratio. At 1 mL stock solution aliquot, there was no more color change on the lead acetate tape, indicating full scavenging of sulfide anion at present with 100% atomic efficacy. In addition, the reaction fluid mixtures in the presence of microfibrillated cellulose dispersant (with stock solutions 1, 3 and 4) under stirring and quiescent afterwards were completely homogeneous, indicating that the reaction product, zinc sulfide and ferrous sulfide respectively, was fully dispersed by the respective fluid compositions disclosed in this invention, safeguarded from the undesirable phase separation. On the other hand, in the absence of microfibrillated cellulose, the corresponding fluid mixtures (with stock solutions 2 and 5) gradually turn into cloudy appearances, indicating the scavenging product, MS, tend to precipitate over time. This would cause a different type but challenging hazard to both the formation and the wellbore.

### Example 2: Suspension Capability Tests

An Exilva™ MFC dispersion of 0.25 wt % active 100 mL was placed in an oven at 140° F., higher than the optimal operational temperature of 131° F. by a typical triazine-based H₂S scavenger in a bubbling tower.

A few particles of 24/40 mesh bauxite proppants (SG 3.56) were placed at the top surface of the Exilva™ solution and remained there (without settled down to the bottom of the fluid) throughout an elongated testing period of 9 weeks. This is an unambiguous indication that a combination of Exilva™'s superior viscosity and elasticity can maintain their uncompromised suspension performance above typical triazine H₂S scavenger operation temperature over an extended period of time.

### Example 3: Sulfide Scavenging Performance Test for Triazine-Based Treatment

### Materials

MEA-triazine: ARLOX HS700 obtained from Baker Hughes Inc
Microfibrillated cellulose: Exilva™ obtained from Borregaard AS
Source of sulfide: sodium sulfide nonahydrate (CAS #1313-82-2) obtained from Sigma Aldrich.

Triazine and Exilva were pre-mixed, while appropriate aliquots of sulfide solution are added in with minimal agitation to homogenize. The reaction mixtures were kept in a water bath at 131° F. under static conditions.

The observations are summarised in Table 4.

TABLE 4

| Scavenger | Sulfide Loading Level/ppm | | |
|---|---|---|---|
| Formulation | 100 | 500 | 1000 |
| MEA- Triazine 50 | Scale onset | Scale onset | Scale onset |
| mL | observed in | observed in | observed in 90 |
| | 120 minutes | 100 minutes | minutes |
| MEA-Triazine 50 | No scale onset | No scale onset | Scale onset |
| mL + Exilva 0.25 | observed in 14 | observed in 14 | observed on |
| wt % | days | days | 14th day |
| MEA-Triazine 50 | No scale onset | No scale onset | No scale onset |
| mL + Exilva 1.00 | observed in 14 | observed in 14 | observed in 14 |
| wt % | days | days | days |

This demonstrates the suitability of MFC as an advantageous dispersant for this particular application.

It will be appreciated that the described embodiments are not meant to limit the scope of the present invention, and the present invention may be implemented using variations of the described examples.

1. A composition capable of scavenging or reducing sulfur-containing compounds in a fluid, the composition comprising:
a hydrogen sulfide scavenger; and
a dispersant, wherein the dispersant comprises or consists of microfibrillated cellulose (MFC).

2. A composition according to claim 1, wherein the composition is capable of scavenging or reducing hydrogen sulfide in the fluid.

3. A composition according to a claim 1, wherein the dispersant is present at a concentration of about 0.01-2 wt %, based on the total weight of the composition.

4. A composition according to claim 3, wherein the dispersant is present at a concentration of about 0.1-1 wt %, based on the total weight of the composition.

5. A composition according to claim 1, wherein the hydrogen sulfide scavenger comprises or consists of a lignosulfonate or derivative thereof.

6. A composition according to claim 5, wherein the hydrogen sulfide scavenger comprises or consists of a lignosulfonate metal salt.

7. A composition according to claim 6, wherein the metal is a polyvalent metal cation.

8. (canceled)

9. A composition according claim 1, wherein the hydrogen sulfide scavenger comprises or consists of a metal organic framework (MOF).

10. (canceled)

11. A composition according to 1, wherein the hydrogen sulfide scavenger comprises or consists of a metal lignosulfonate encapsulated in a metal organic framework.

12. (canceled)

13. A composition according to claim 1, wherein the hydrogen sulfide scavenger comprises or consists of a metal salt encapsulated in a metal organic framework.

14. A composition according to claim 13, wherein the metal salt contains one or more polyvalent metal cations.

15. A composition according to claim 1, wherein the hydrogen sulfide scavenger is present at a concentration of about 0.01-90 wt %, based on the total weight of the composition.

16. A composition according to claim 1, wherein the hydrogen sulfide scavenger comprises or consists of a metal salt encapsulated in a metal salt.

17. A composition according to claim 16, wherein the metal salt contains one or more polyvalent metal cations.

18. (canceled)

19. A composition according to claim 1, wherein the hydrogen sulfide scavenger comprises or consists of a triazine compound.

20. A composition according to claim 19, wherein the triazine compound is a triazine compound made from or derived from monoethanolamine (MEA) or methylamine (MA).

21. (canceled)

22. A composition capable of treating a wellbore, subterranean formation or reservoir, the composition comprising:
a treatment fluid;
a hydrogen sulfide scavenger; and
a dispersant, wherein the dispersant comprises or may consist of microfibrillated cellulose (MFC).

23. A method of scavenging or reducing sulfur-containing compounds in a treatment fluid, the method comprising providing in the treatment fluid a composition comprising:
a hydrogen sulfide scavenger; and
a dispersant, wherein the dispersant comprises or may consist of microfibrillated cellulose (MFC).

24. A method of treating a wellbore, subterranean formation or reservoir, or surface facility, the method comprising injecting in the wellbore, subterranean formation or reservoir, or surface facility a composition comprising:
a treatment fluid;
a hydrogen sulfide scavenger; and
a dispersant, wherein the dispersant comprises or may consist of microfibrillated cellulose (MFC).

25. A method of treating a fluid retrieved from a wellbore, subterranean formation or reservoir, or surface facility, the method comprising contacting the fluid with a composition comprising:
a hydrogen sulfide scavenger; and
a dispersant, wherein the dispersant comprises or may consist of microfibrillated cellulose (MFC).

26. (canceled)
